(19) United States
(12) Patent Application Publication
(10) Pub. No.: US 2024/0020177 A1
(43) Pub. Date: Jan. 18, 2024

(54) METHOD AND SYSTEM FOR END-TO-END EMULATION OF HARDWARE OFFLOADING OPERATION

(71) Applicants: Lemon Inc., Grand Cayman (KY); Beijing Volcano Engine Technology Co., Ltd., Beijing (CN)

(72) Inventors: Hui ZHANG, Los Angeles, CA (US); Chul LEE, Los Angeles, CA (US); Bo LI, Beijing (CN); Shan XIAO, Beijing (CN); Ping ZHOU, Los Angeles, CA (US); Fei LIU, Los Angeles, CA (US)

(21) Appl. No.: 18/475,912

(22) Filed: Sep. 27, 2023

(51) Int. Cl. G06F 9/50; G06F 9/455

(52) U.S. Cl. CPC G06F 9/5083; G06F 9/455

(57) ABSTRACT

System and method for providing a platform for emulating hardware offloading, which when executed on a host system, includes a guest system running on the host system, the guest system configured to receive a data processing command; a virtual device interface communicating between the guest system and an accelerator emulator; and a hardware accelerator emulated by the accelerator emulator for executing the data processing command received through the virtual device interface, wherein the hardware accelerator including an offloading hardware component and a controller component.

### FIELD

The embodiments described herein pertain generally to hardware offloading system. More specifically, the embodiments described herein pertain to methods and systems for end-to-end emulation and evaluation of offloading operations by a hardware accelerator having a controller emulation and an offloading hardware emulation that emulate the interaction between hardware and software components of the hardware accelerator being emulated.

### BACKGROUND

Hardware offloading includes delegating computing tasks from a central processing unit (CPU) to a hardware accelerator that is a specialized hardware component that includes components that may accelerate data processing and analysis, improve performance, and reduce power consumption. The accelerator can be designed particularly for certain data processing functions. Hardware prototyping and/or proof of concept designs of an accelerator can involve substantial time and capital investment.

### SUMMARY

The embodiments described herein pertain generally to hardware offloading system. More specifically, the embodiments described herein pertain to methods and systems for end-to-end emulation and evaluation of offloading operations by a hardware accelerator having a controller emulation and an offloading hardware emulation that emulate the interaction between hardware and software components of the hardware accelerator being emulated.

In Big Data or Machine Learning applications, hardware offloading can be utilized to accelerate the data processing operations that support the applications. A system handling the data processing operations and supporting the function of the application can be created for the applications.

End-to-end emulation of the hardware/software co-design system can be provided to evaluate the system that executes the offloading operation using one or more hardware accelerators. It is appreciated that a co-design system having hardware accelerators for offloading operation is complicated and the performance of the system as a whole can be unpredictable based on the performance characteristic of the individual components. By end-to-end emulating the offloading system, performance of and compatibility among the hardware and software components in the system can be projected and evaluated. Issues or bottlenecks in the software and/or hardware design, their integration, and the system architecture may be identified from monitoring the emulation and monitoring performance statics obtained from the emulation. Evaluation and performance optimization may be conducted with the emulation, avoiding and/or reducing the need for physical prototyping.

In an embodiment, a platform for emulating hardware offloading, when executed on a host system, includes a guest system running on the host system, the guest system being configured to receive a data processing command; a virtual device interface communicating between the guest system and an accelerator emulator; and a hardware accelerator emulated by the accelerator emulator for executing the data processing command received through the virtual device interface, wherein the hardware accelerator including an offloading hardware component and a controller component.

In an embodiment, the controller component emulates parsing the data processing command from the guest system.

In an embodiment, the offloading hardware component emulates executing of the data processing command in the hardware accelerator.

In an embodiment, the hardware accelerator is emulated in a Quick Emulator (QEMU) as a virtual device in communication with the guest system.

In an embodiment, the host system includes an emulated storage device for emulating storing data processed by the hardware accelerator.

In an embodiment, the guest system further comprises an emulator library included in the guest system, the emulator library providing an application programming interface (API) to offload a data operation according to the data processing command to the hardware accelerator emulated by the accelerator emulator.

In an embodiment, the hardware accelerator is emulated by the accelerator emulator as a non-volatile memory express (NVMe) device, and an emulator library includes a NVMe driver for controlling the NVMe device.

In an embodiment, the platform includes a profiler acquiring performance statistics from the guest system.

In an embodiment, the profiler runs with a provided user application or an emulator library to collect the performance statistics.

In an embodiment, the profiler or an emulator library includes a profiler library that provides an API for hooks or callbacks of performance statistics to the profiler.

In an embodiment, a method for emulating a hardware accelerator is disclosed. The method includes a guest system running on a host system providing an emulation platform; the guest system receiving a data processing command; an accelerator emulator emulating the hardware accelerator; the hardware accelerator receiving the data processing command through a virtual device interface; and a controller component of the hardware accelerator controlling an offloading hardware component of the hardware accelerator to emulate executing the data processing command by the hardware accelerator.

In an embodiment, the accelerator emulator emulating a hardware accelerator in a Quick Emulator (QEMU) as a virtual device in communication with the guest system.

In an embodiment, the method includes an emulated storage device storing data processed by the hardware accelerator emulated by the accelerator emulator.

In an embodiment, the method includes the accelerator emulator implementing the hardware accelerator as a non-volatile memory express (NVMe) device, and an emulator library in the guest system providing a NVMe driver for controlling the NVMe device to execute the data processing command.

In an embodiment, the method includes a profiler acquiring performance statistics from the guest system.

In an embodiment, a non-transitory computer readable medium having computer-executable instructions stored thereon that, upon execution, cause one or more processors to perform operations for emulating a hardware accelerator includes running a guest system in a host system providing an emulation platform; receiving a data processing command from the guest system; emulating a hardware accelerator using an accelerator emulator; receiving into the hardware accelerator the data processing command through a virtual device interface; and controlling an offloading hardware component of the hardware accelerator with a controller component of the hardware accelerator to emulate executing the data processing command by the hardware accelerator.

In an embodiment, the non-transitory computer readable medium includes comprising with the accelerator emulator a hardware accelerator in a Quick Emulator (QEMU) as a virtual device in communication with the guest system.

In an embodiment, the non-transitory computer readable medium includes storing data processed by the hardware accelerator in an emulated storage device emulated by the accelerator emulator.

In an embodiment, the non-transitory computer readable medium includes implementing with the accelerator emulator the hardware accelerator as a non-volatile memory express (NVMe) device, and providing a NVMe driver in an emulator library of the guest system for controlling the NVMe device to execute the data processing command.

In an embodiment, the non-transitory computer readable medium includes acquiring performance statistics from the guest system with a profiler.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Non-limiting and non-exhaustive descriptions are described with reference to the following drawings. The components in the figures are not necessarily to scale, emphasis instead being placed upon illustrating principles. In the detailed description that follows, embodiments are described as illustrations only since various changes and modifications may become apparent to those skilled in the art from the following detailed description.

FIG. 1 is a schematic view of a host system to emulate end-to-end (E2E) hardware offloading arranged in accordance with at least some embodiments described herein.

FIG. 2 is a schematic view of the architecture an E2E emulator, arranged in accordance with at least some embodiments described herein.

FIG. 3 is a flow chart illustrating a profiling operation, in accordance with at least some embodiments described herein.

FIG. 4 is a schematic view of the architecture of an E2E hardware offloading emulator arranged in accordance with at least some embodiments described herein.

FIG. 5 is a flow chart illustrating a method of E2E emulation, in accordance with at least some embodiments described herein.

Like reference numbers represent like parts throughout.

### DETAILED DESCRIPTION

The embodiments described herein pertain generally to hardware offloading system. More specifically, the embodiments described herein pertain to methods and systems for end-to-end emulation and evaluation of offloading operations by a hardware accelerator having a controller emulation and an offloading hardware emulation that emulate the interaction between hardware and software components of the hardware accelerator being emulated.

In the following detailed description, particular embodiments of the present disclosure are described herein with reference to the accompanying drawings, which form a part of the description. In this description, as well as in the drawings, like-referenced numbers represent elements that may perform the same, similar, or equivalent functions, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

Additionally, the present disclosure may be described herein in terms of functional block components and various processing steps. It should be appreciated that such functional blocks may be realized by any number of hardware and/or software components configured to perform the specified functions.

The scope of the disclosure should be determined by the appended claims and their legal equivalents, rather than by the examples given herein. For example, the steps recited in any method claims may be executed in any order and are not limited to the order presented in the claims. Moreover, no element is essential to the practice of the disclosure unless specifically described herein as “critical” or “essential”.

As referenced herein, a “network” or a “computer network system” is a term of art and may refer to interconnected computing devices that may exchange data and share resources with each other. It is to be understood that the networked devices may use a system of rules (e.g., communications protocols, etc.), to transmit information over wired or wireless technologies.

As referenced herein, a “NVMe protocol or interface” may refer to non-volatile memory express protocol that provides a quick interface between computer processing units and storage devices, such as solid-state devices (SSDs). The NVMe protocol or interface may use a Peripheral Component Interconnect Express (PCIe) bus that provides a leaner interface for accessing the SSDs.

In some computer networking systems, such as, cloud-based storage environments, e.g., in a data center or in a server system, hardware offloading operations may be provided such that a host device having a controller, such as, a central processing unit (CPU), may offload certain functionalities or operations from the host device to a controller (or CPU) on a server connected to the storage device(s). For example, in some embodiments, the processor-enabled server, e.g., having hardware, software, and/or firmware operations, may include various hardware offloading engines, such as data streaming accelerators and in-memory analytics accelerators. In an example embodiment, the host device may be designed, programmed, or otherwise configured to provide (e.g., transmit/send) an offloading command to the server for hardware offloading operations/functionalities to the hardware offloading engines on the processor-enabled server (and/or the processor-enabled server may be designed, programmed, or otherwise configured to fetch the offloading command). The E2E emulation platform disclosed herein may be configured to emulate and/or evaluate such computer networking systems.

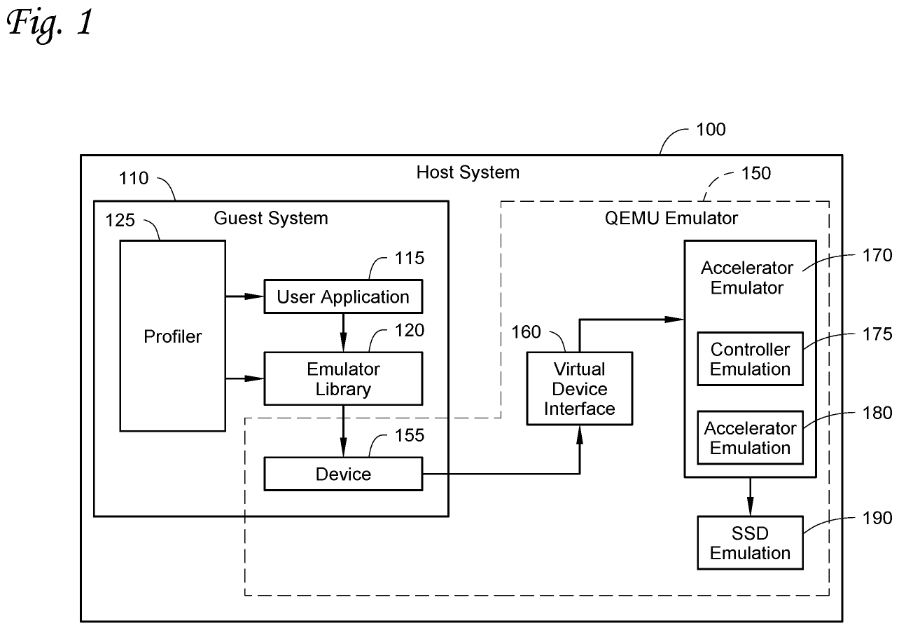

FIG. 1 is a schematic view of a host system 100 to emulate E2E hardware offloading arranged in accordance with at least some embodiments described herein.

The host system 100 provides an E2E hardware offloading emulation platform. In an embodiment, the host system 100 provides an E2E emulation platform for E2E emulation of one or more hardware accelerators. The emulation of a hardware accelerator includes hardware and/or software components for emulating the execution of one or more offloading operations. In an embodiment, the host system 100 can be a computer, a network of computers, a cloud computing center, or the like. The host system 100 executes a non-transitory computer readable medium to provide the E2E emulation platform configured to emulate the hardware accelerator.

As shown in FIG. 1, the E2E emulation platform, when executed by the host system 100, includes a guest system 110, an emulator interface 160, an accelerator emulator 170, and a SSD emulation 190. In an embodiment, the guest system 110, the emulator interface 160, the accelerator emulator 170, and the SSD emulation 190 are operated in a QEMU process running on the host system 100.

The guest system 110 is a system communicating with the host system 100. The guest system 110 provides the performance and function of a guest device that requests one or more hardware offloading operation. For example, the guest system 100 can include software packages or modules to request data processing offloaded from a CPU of the guest system 100 to a hardware accelerator such as Graphics Processing Units (GPUs), Field-Programmable Gate Arrays (FPGAs), or Application-Specific Integrated Circuits (ASICs), or the like. In an embodiment, the guest system 110 is a virtual system, such as a virtual machine in communication with, and/or generated by, the host system 100. The guest system 110 can include a virtual processor, a virtual random-access memory (RAM), a virtual storage, drivers, and/or the like, for virtually executing an operating system, an application, or the like, and communicating with another physical or virtual device (e.g., a hardware accelerator) such as a device 155.

A user application 115 can be loaded into and/or executed by the guest system 110. The user application 115 generally performs application function(s). The user application 115 issues one or more data processing commands to request one or more data processing operations to support the application function(s) of the user application 115. The application function(s) can include filtering, decompressing, decoding, machine learning, and/or the like. The guest system 110 executes the processing command by its processor and/or by offloading to a hardware accelerator.

An emulator library 120 interfaces between the user application 115 and hardware, or emulated hardware, for offloading operation. The emulator library 120 includes one or more application programming interfaces (APIs) or a unified API to connect, transmit, transcribe, and/or compile the processing command from the user application 115 to readable commands for a physical or virtual device such as the device 155. In an embodiment, the emulator library 120 includes an NVMe driver for controlling an actual/physical NVMe device or an emulated or virtual NVMe device. In an embodiment, the emulator library 120 includes Platform API, Runtime API, Memory API, Storage API, to provide a unified API for a hardware offloading operation.

A profiler 125 acquires performance data of the components (e.g., the guest system 110) in the host system 100. For example, performance data of the hardware and/or software components of the host system 100 can be acquired by the profiler 125. In an embodiment, the profiler 125 can include software module(s) executed in the guest system 110 configured to receive, monitor, analysis, and/or visualize performance data. In an embodiment, the profiler 125 communicates with the guest system 110, and/or runs on the guest system 100, to acquire the operation performance data of the guest system 110. The profiler 125 acquires data while the guest system 110 is running the user application 115. In an embodiment, the profiler 125 communicates with the user application 115 and/or the emulator library 120 to acquire performance data. The profiler may include a profiler library that provides one or more API for profiler hooks and/or callbacks. The profiler library shares or integrates with the user application 115 and/or the emulator library 120 to provide hooks and callback functions for the profiler 125. Performance statistics may include runtime data (e.g., clock speed, runtime, latency, error counts, etc.).

It is appreciated that E2E emulation may be performed to emulate a hardware accelerator against the specific data processing request of the user application 115 to emulate the E2E performance of the hardware and the software components that execute the offloading operation. By monitoring the performance at various components in the host system 100 during the offloading operation, performance bottlenecks by any of the hardware and software may be identified in the E2E emulation for making diagnosis, improvements, optimizations, and/or the like, to the hardware and/or software architecture.

The device 155 communicates with the user application 115 through the emulator library 120 for performing one or more data processing commands from the user application 115 interfaced by the emulator library 120. In an embodiment, the device 155 is implemented as a NVMe device that communicates with, e.g., the emulator library 120 using NVMe protocol. In an embodiment, the device 155 is a virtual device that provides the QEMU emulator 150 for emulating a hardware accelerator within the QEMU emulator 150. It is appreciated that the QEMU emulator 150 may emulate one or more components operating in the host system 100 and/or interacting with the guest system 110. For example, the QEMU emulator 150 can emulate and provide the emulator interface 160, the accelerator emulator 170, and/or the SSD emulation 190 for the host system 100.

The emulator interface 160 facilitates the communication between the emulated device 155 and the accelerator emulator 170. In an embodiment, the emulator interface 160 is a QEMU virtual device interface configured to interface between a virtual device 155 using NVMe protocol and an accelerator emulator 170 emulated in an QEMU emulator 150. The emulator interface 160 can include one or more API, a unified API, one or more shared library, one or more drivers, and/or the like for interfacing between the accelerator emulator 170 and a device (e.g., device 155).

The accelerator emulator 170 creates an emulated hardware accelerator to performance a data process function offloaded from a CPU. The CPU may be a virtual processor of the guest system 110. In an embodiment, the accelerator emulator 170 is provided as emulated device by an QEMU emulator. The accelerator emulator 170 uses QUME to emulate hardware component and the software component of a hardware accelerator. The software component of the emulated accelerator can be a controller emulation 175. The controller emulation 175 can include instructions for processing data according to the data processing function. The instructions can include, for example, parsing offloading commands, sending low-level instructions to the offloading hardware emulation 180 to enable the execution of offloading command(s), and/or the like. In an embodiment, the controller emulation 175 is configured to process instructions to submit and/or complete an offloading function according to the offloading command. The hardware component of the emulated accelerator can be an offloading hardware emulation 180. For example, the offloading hardware emulation 180 can emulate a custom data processing algorithm/function and/or circuitry design of a hardware accelerator for performing one or more data processing functions according to an offloading command. In an embodiment, the accelerator emulator 170 is emulated in the host system 100 by the QEMU emulator 150.

The SSD emulation 190 emulates a hardware receiving and storing of data. The SSD emulation 190 can emulate the function and performance of a physical SSD that receives data from another operation.

In an embodiment, the QEMU emulator 150 is included and/or executed on the host system 100. For example, the QEMU emulator may be run in the operating system of the host system 100. QEMU emulator is a system to emulate one or more pieces of custom or standard hardware. In an embodiment, the host system 100 includes the QEMU emulator 150 to provide one or more virtual/emulated hardware components in the host system 100. The QEMU emulator 150 emulates virtual devices to interact with physical or other virtual devices included in, or connected to, the host system 100. In an embodiment, the device 155, the emulator interface 160, the accelerator emulator 170, and the SSD emulation 190 are emulated in the QEMU emulator 150.

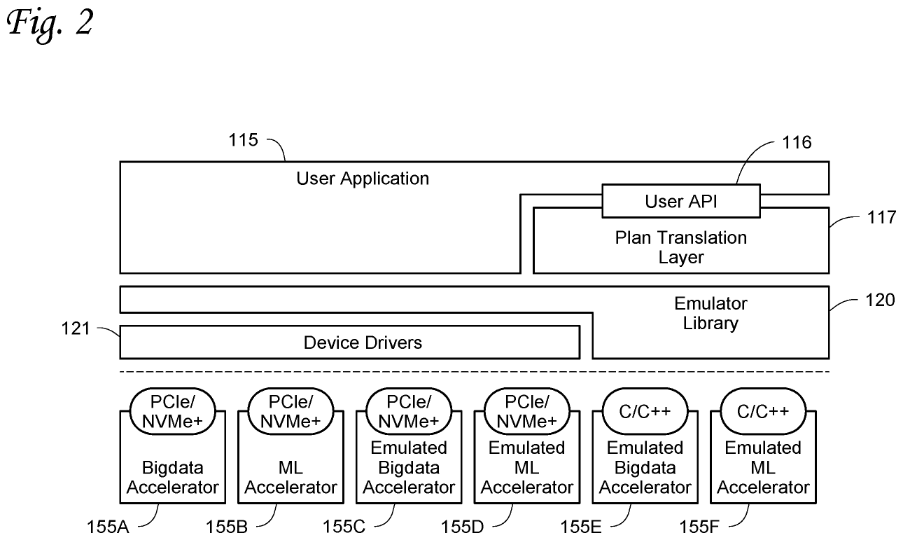

FIG. 2 is a schematic view of the architecture of an E2E emulator, arranged in accordance with at least some embodiments described herein. In an embodiment, the E2E emulator can run the host system 100 as discussed above with respect to FIG. 1. As shown in FIG. 2, the emulator library 120 interfaces between the user application 115 and one or more devices 155A-F. The emulator library 120 can be configured to deliver the command from the user application 115 to emulated and/or physical devices (e.g., devices 155A-F).

The user application 115 can include an execution engine for communicating a data processing command for a data processing function (e.g., filtering, decoding, decompression, etc.). The execution engine can be a unified execution engine provided for data processing and envelopment of data management systems. In an embodiment, the user application 115 can be configured for the emulator library 120 and communicating directly with the emulator library 120 for transmitting and/or transcribing the data processing command.

In an embodiment, the user application 115 communicates with the emulator library 120 through an intermediary layer and/or API. For example, the user application 115 may transcribe the data processing command through a user API 116 for transmitting the command to a plane translation layer 117. The plane translation layer 117 can be a software module translating the command from the user application 115 to another version compatible with the emulator library 120. Then, the plan translation layer 117 provides the transcribed command to the emulator library 120. In an embodiment, the user application 115 issues a data processing command using query engines.

The emulator library 120 receives the command from the user application 115, or through the plan translation layer 117, to be transmitted to a device, such as the device 155 (shown in FIG. 1) or 155A-F. The library 120 can include API and/or drivers for controlling the device to perform offloading operations. In an embodiment, a device driver 121 is provided to communicate with one or more physical or virtual devices. The physical or virtual devices can be accelerators for Big Data or Machines Learning operation or function (e.g., decompression, filtering, decoding, etc.).

The physical or virtual device may be implemented with PCIe/NVMe+ protocol (e.g., devices 155A-D), controlled by an C/C++ interface, or the like.

In an embodiment, the emulator library 120 is configured to interface with and provide command(s) to real accelerators (e.g., physical or actual device 155A or 155B). In such embodiment, the emulation may be performed to evaluate the user application 115 and/or the emulator library 120, and/or the compatibility with real accelerators (e.g., actual or physical accelerators).

In an embodiment, the emulator library 120 is configured to interface with and/or provide command(s) to an emulated accelerator (e.g., device 155C or 155D) controllable by PCIe/NVMe+ protocol. In such embodiment, the emulated accelerators may be a prototype or a design concept for performance evaluation.

In an embodiment, the emulated device (e.g., device 155E or 155F) can be C/C++ interface devices, for example, for early stage integration and testing. The C/C++ interface device can be virtual devices implemented and interfaced in C or C++ language. In such embodiments, a device driver may be omitted.

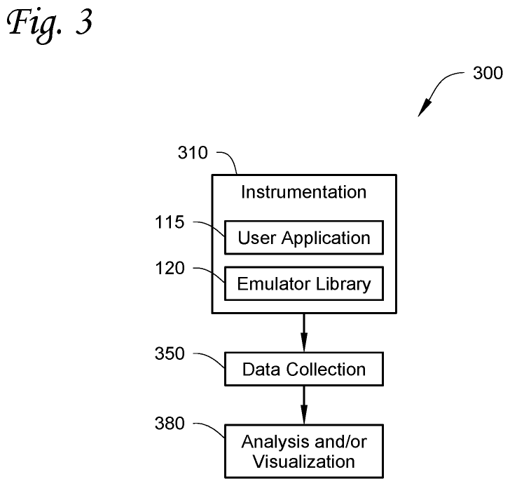

FIG. 3 is a flow chart illustrating a profiling operation 300, in accordance with at least some embodiments described herein. A profiler (e.g., profiler 125 of FIG. 1) can perform the profiling operation 300 to acquire performance data of components in a host system (e.g., host system 100), a guest system (e.g., guest system 110), an emulated hardware accelerator, and/or the like. In an embodiment, the profiling operation 300 can be configured to acquire performance data of components in the host system 100 (shown in FIG. 1), the guest system 110 (shown in FIG. 1), the user application 115, the emulator library 120, and/or the like.

At 310, the profiler performs instrumentation to acquire performance statistics. In an embodiment, at instrumentation, the profiler includes a process that operates alongside the user application 115 that records and collects performance statistics during the run time of a process and/or the user application 115. In another embodiment, the profiler shares a profiler library with the user application 115 and/or the emulator library 120. The profiler library integrates with the user application 115 and/or the emulator library 120 to provide profiler hooks and callbacks for the profiler requesting and/or receiving performance statistics. Performance statistics may include runtime data (e.g., clock speed, runtime, latency, error counts, etc.). Then, the method 300 proceeds to 350.

At 350, the profiler collects the data of performance statistics, for example, by organizing the data in the memory of the guest system and/or the host system. Then, the method 300 proceeds to 380.

At 380, the profiler aggregates and analyzes the collected data and visualizes the collected data. The collected data can be visualized on a user interface for a user to review the collected data and evaluate the performance of the emulated hardware accelerator, the user application 115, the emulator library 120, or the like, and/or identify bottlenecks in the design of the hardware and/or software components of the hardware accelerator being emulated. In an embodiment, the collected data may be transmitted, e.g., via an API, to another module or application for processing and visualizing.

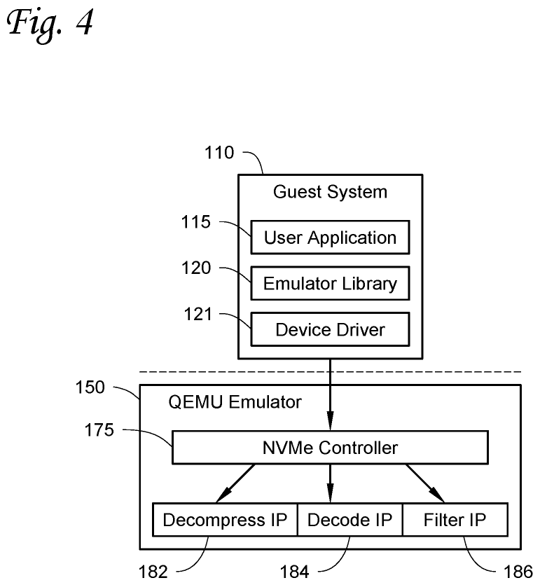

FIG. 4 is a schematic view of the architecture of a hardware offloading emulator arranged in accordance with at least some embodiments described herein. In an embodiment, the hardware offloading emulator can be configured to emulate control software and/or hardware component of a hardware accelerator. In an embodiment, the hardware accelerator is emulated in the QEMU emulator 150. The QEMU emulated hardware accelerator can be implemented as an NVMe device controlled by a driver 121 using NVMe protocol. In an embodiment, the user application 115, the E2E emulation library 120, and the driver 121 are provided in the guest system 110.

The driver 121 transmits and/or transcribes the data processing command from the user application 115 in the guest system 110 to the QEMU emulator 150. In the QEMU emulator 150, the controller emulation 175 receives and parses the commands from the guest system 110 and instructs offloaded functions to perform data processing on the QEMU emulated hardware accelerator (e.g., the controller emulation 175, the accelerator emulation 180, or the like). In an embodiment, the offloaded functions can include decompressing 182, decoding 184, filtering 186, and/or the like. The offloaded functions can each be configured for different workloads, or specific data processing, to support different user applications, such as data analytics, machine learning training, video processing, or the like. In an embodiment, the QEMU emulator 150 is implemented as a multi-threaded program in which each offloaded function is provided with one or more processor threads. One or more cores of a processor, or a virtual processor, can be assigned for executing the offloaded function(s). By increasing the number of cores of the processor, or the virtual processor, more offloaded functions can be executed in parallel. It is appreciated that QEMU emulator 150 can provide a thread pool to consolidate the computational resource(s) provided, e.g., by a multi-threaded CPU and/or emulating a plurality of components in parallel. Kernel functions of the operating system (e.g., a Linux system running the QEMU) can assign a varying number of CPU cores to the QEMU emulator 150 and/or the accelerator emulator (e.g., the accelerator emulator 170 of FIG. 1; or the controller 175 and the accelerators 182, 184, and/or 186 of FIG. 4; or the like) for emulating the executing of the offloaded function(s). The thread pool can be provided to emulate the execution of a plurality of the same or different emulated hardware accelerators 182, 184, and/or 186 in parallel for emulating an offloading system utilizing multiple accelerators. The computational power provided to the emulation of accelerators 182, 184, and/or 186, and/or the accelerator emulator 170 (shown in FIG. 1) can be adjusted by the thread pool and kernel functions adjusting computational resources (e.g., emulated cores, actual cores, or the like) assigned to the emulation of accelerator(s) and/or the accelerator emulator 170. By adjusting the computational power, performance of an emulated offloading system can be evaluated and bottlenecks can be identified.

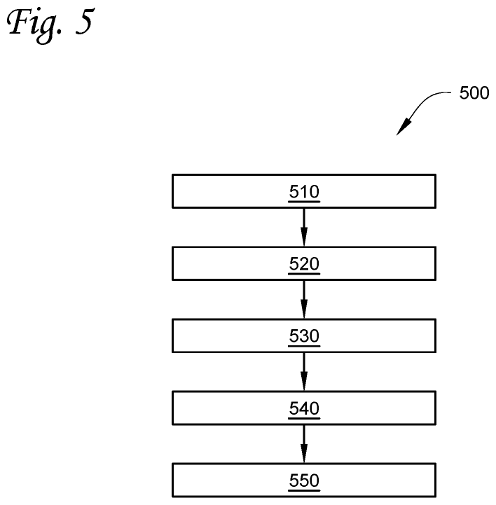

FIG. 5 is a flow chart illustrating a method 500 for emulating a hardware accelerator in accordance with at least some embodiments described herein. In an embodiment, the method can be performed by a host system (e.g., host system 100 of FIG. 1) to provide an E2E emulation platform for emulating the hardware and the software components of a hardware accelerator. The emulation can be used to identify compatibility and/or performance issues of the hardware accelerator being emulated. In an embodiment, a non-transitory computer readable medium can be configured to instruct a processor to perform the method 500. It is appreciated that, the one or more software programs, when being executed by the one or more processors, may cause the one or more processors to perform the method(s) described in any embodiments described herein. Also, it is to be understood that a computer readable non-volatile medium may be provided according to the embodiments described herein. The computer readable medium stores computer programs that are used to, when being executed by a processor, perform the method(s) described in any embodiments described herein.

The method 500 begins at 510. At 510, the method 500 includes a guest system running on a host system providing an emulation platform. The guest system can be a virtual system created by the host system. Then, the method 500 proceeds to 520.

At 520, the method 500 includes a user application in the guest system originating a data processing command. The method 500 originates a data processing command for example by the user application excited by and/or loaded in the guest system can originate the data processing command, for example, for supporting one or more function of a user application. Then, the method 500 proceeds to 530.

At 530, the method 500 includes an accelerator emulator emulating the hardware accelerator, e.g., a real hardware accelerator. The method 500 emulates the hardware accelerator that receives the data processing command from, e.g., the user application, through a virtual device interface. In an embodiment, the hardware emulator is implemented by the hardware accelerator as a non-volatile memory express (NVMe) virtual device. The hardware emulator can be an QEMU emulator. In an embodiment, the accelerator emulator implements the hardware accelerator as a NVMe virtual device. The method 500 can provide an emulator library in the guest system for providing a NVMe driver for controlling the NVMe virtual device to execute the data processing command. Then, the method 500 proceeds to 540.

At 540, the method 500 includes an accelerator emulator emulating the hardware accelerator. The method 500 can use the accelerator emulator to emulate a controller component (e.g., a controller emulation 175 of FIG. 1) and a hardware component (e.g., the accelerator emulation 180 of FIG. 1). The method 500 controls the hardware component using the controller component of the hardware accelerator and emulates executing the data processing command by the hardware accelerator. Then, the method 500 proceeds to 550.

At 550, the method 500 includes an emulated storage device storing data processed by the hardware accelerator emulated by the accelerator emulator.

It is to be understood that the processes described with reference to the flowcharts of FIG. and/or the processes described in other figures may be implemented as computer software programs or in hardware. The computer program product may include a computer program stored in a computer readable non-volatile medium. The computer program includes program codes for performing the method shown in the flowcharts and/or GUIs.

It is to be understood that the disclosed and other solutions, examples, embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., a field programmable gate array, an application specific integrated circuit, or the like.

Processors suitable for the execution of a computer program include, by way of example, both general and special purpose microprocessors, and any one or more processors of any kind of digital computer. Generally, a processor will receive instructions and data from a read only memory or a random-access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., erasable programmable read-only memory, electrically erasable programmable read-only memory, and flash memory devices; magnetic disks, e.g., internal hard disks or removable disks; magneto optical disks; and compact disc read-only memory and digital video disc read-only memory disks. The processor and the memory can be supplemented by, or incorporated in, special purpose logic circuitry.

It is to be understood that different features, variations and multiple different embodiments have been shown and described with various details. What has been described in this application at times in terms of specific embodiments is done for illustrative purposes only and without the intent to limit or suggest that what has been conceived is only one particular embodiment or specific embodiments. It is to be understood that this disclosure is not limited to any single specific embodiments or enumerated variations. Many modifications, variations and other embodiments will come to mind of those skilled in the art, and which are intended to be and are in fact covered by both this disclosure. It is indeed intended that the scope of this disclosure should be determined by a proper legal interpretation and construction of the disclosure, including equivalents, as understood by those of skill in the art relying upon the complete disclosure present at the time of filing.

Aspects:

Aspect 1. A platform for emulating hardware offloading, the platform, which when executed on a host system, comprises: a guest system running on the host system, the guest system being configured to receive a data processing command; a virtual device interface communicating between the guest system and an accelerator emulator; and a hardware accelerator emulated by the accelerator emulator for executing the data processing command received through the virtual device interface, wherein the hardware accelerator including an offloading hardware component and a controller component.

Aspect 2. The platform of aspect 1, wherein the controller component in the accelerator emulator emulates parsing the data processing command from the guest system.

Aspect 3. The platform of aspect 1 or 2, wherein the offloading hardware component in the accelerator emulator emulates executing of the data processing command in the hardware accelerator.

Aspect 4. The platform of any one of aspects 1-3, wherein the hardware accelerator is emulated in a Quick Emulator (QEMU) as a virtual device in communication with the guest system.

Aspect 5. The platform of any one of aspects 1-4, wherein the host system includes an emulated storage device for emulating storing data processed by the hardware accelerator.

Aspect 6. The platform of any one of aspects 1-5, wherein the guest system further comprises an emulator library included in the guest system, the emulator library providing an application programming interface (API) to offload a data operation according to the data processing command to the hardware accelerator emulated by the accelerator emulator.

Aspect 7. The platform of any one of aspects 1-6, wherein the hardware accelerator is emulated by the accelerator emulator as a non-volatile memory express (NVMe) device, and an emulator library includes a NVMe driver for controlling the NVMe device.

Aspect 8. The platform of any one of aspects 1-7, further comprising a profiler acquiring performance statistics from the guest system.

Aspect 9. The platform of aspect 8, wherein the profiler runs with a provided user application or an emulator library to collect the performance statistics.

Aspect 10. The platform of aspect 8 or 9, wherein the profiler or an emulator library includes a profiler library that provides an API for hooks or callbacks of performance statistics to the profiler.

Aspect 11. A method for emulating a hardware accelerator, the method comprising: a guest system running on a host system providing an emulation platform; the guest system receiving a data processing command; an accelerator emulator emulating the hardware accelerator; the hardware accelerator receiving the data processing command through a virtual device interface; and a controller component of the hardware accelerator controlling an offloading hardware component of the hardware accelerator to emulate executing the data processing command by the hardware accelerator.

Aspect 12. The method of aspect 11, wherein the accelerator emulator emulating a hardware accelerator in a Quick Emulator (QEMU) as a virtual device in communication with the guest system.

Aspect 13. The method of aspect 11 or 12, further comprising: an emulated storage device storing data processed by the hardware accelerator emulated by the accelerator emulator.

Aspect 14. The method of any one of aspects 11-13, further comprising: the accelerator emulator implementing the hardware accelerator as a non-volatile memory express (NVMe) device, and an emulator library in the guest system providing a NVMe driver for controlling the NVMe device to execute the data processing command.

Aspect 15. The method of any one of aspects 11-14, further comprising: a profiler acquiring performance statistics from the guest system.

Aspect 16. A non-transitory computer readable medium having computer-executable instructions stored thereon that, upon execution, cause one or more processors to perform operations for emulating a hardware accelerator comprising: running a guest system in a host system providing an emulation platform; receiving a data processing command from the guest system; emulating a hardware accelerator using an accelerator emulator; receiving into the hardware accelerator the data processing command through a virtual device interface; and controlling an offloading hardware component of the hardware accelerator with a controller component of the hardware accelerator to emulate executing the data processing command by the hardware accelerator.

Aspect 17. The non-transitory computer readable medium of aspect 16, further comprising: emulating with the accelerator emulator a hardware accelerator in a Quick Emulator (QEMU) as a virtual device in communication with the guest system.

Aspect 18. The non-transitory computer readable medium of aspect 16 or 17, further comprising: further comprising: storing data processed by the hardware accelerator in an emulated storage device emulated by the accelerator emulator.

Aspect 19. The non-transitory computer readable medium of any one of aspects 16-18, further comprising: implementing with the accelerator emulator the hardware accelerator as a non-volatile memory express (NVMe) device, and providing a NVMe driver in an emulator library of the guest system for controlling the NVMe device to execute the data processing command.

Aspect 20. The non-transitory computer readable medium of any one of aspects 16-19, further comprising: acquiring performance statistics from the guest system with a profiler.

Aspect 21. A platform for evaluating emulated hardware offloading, the platform, which when executed on a host system, comprises: a guest system running on the host system, the guest system configured to receive a data processing command; a virtual device interface communicating between the guest system and an accelerator emulator; a hardware accelerator emulated by the accelerator emulator for executing the data processing command received through the virtual device interface, wherein the hardware accelerator including an offloading hardware component and a controller component; and a profiler included in the guest system for acquiring performance statistics from the guest system.

Aspect 22. The platform of aspect 21, wherein the controller emulation in the accelerator emulator emulates parsing the data processing command from the guest system.

Aspect 23. The platform of aspect 21 or 22, wherein the offloading hardware emulation in the accelerator emulator emulates executing of the data processing command in the hardware accelerator.

Aspect 24. The platform of any one of aspects 21-23, wherein the hardware accelerator is emulated in a Quick Emulator (QEMU) as a virtual device in communication with the guest system.

Aspect 25. The platform of any one of aspects 21-24, wherein the host system includes an emulated storage device for emulating storing data processed by the hardware accelerator emulated by the accelerator emulator.

Aspect 26. The platform of any one of aspects 21-25, wherein the guest system further comprises an emulator library included in the guest system, the emulator library providing an application programming interface (API) to offload a data operation according to the data processing command to the hardware accelerator emulated by the accelerator emulator.

Aspect 27. The platform of any one of aspects 21-26, wherein the hardware accelerator is emulated by the accelerator emulator as a non-volatile memory express (NVMe) virtual device, and an emulator library includes a NVMe driver for controlling the NVMe virtual device.

Aspect 28. The platform of any one of aspects 21-27, wherein the profiler runs with a provided user application or an emulator library to collect the performance statistics.

Aspect 29. The platform of any one of aspects 21-28, wherein the profiler or an emulator library includes a profiler library that provides an API for hooks or callbacks of performance statistics to the profiler.

Aspect 30. The platform of any one of aspects 21-29, wherein the profiler visualizes the performance statistics acquired from the guest system.

Aspect 31. A method for evaluating an emulated hardware accelerator, the method comprising: a guest system running on a host system providing an emulation platform; the guest system receiving a data processing command; an accelerator emulator emulating a hardware accelerator; the hardware accelerator receiving the data processing command through a virtual device interface; a controller emulation of the hardware accelerator controlling an offloading hardware emulation of the hardware accelerator to emulate executing the data processing command by the hardware accelerator; and a profiler acquiring performance statistics from the guest system.

Aspect 32. The method of aspect 31, wherein the accelerator emulator emulating a hardware accelerator in a Quick Emulator (QEMU) as a virtual device in communication with the guest system.

Aspect 33. The method of aspect 31 or 32, further comprising: an emulated storage device storing data processed by the hardware accelerator emulated by the accelerator emulator.

Aspect 34. The method of any one of aspects 31-33, further comprising: the accelerator emulator implementing the hardware accelerator as a non-volatile memory express (NVMe) device, and an emulator library in the guest system providing a NVMe driver for controlling the NVMe virtual device to execute the data processing command.

Aspect 35. The method of aspect any one of aspects 31-34, wherein the profiler runs with a provided user application or an emulator library to collect the performance statistics.

Aspect 36. The method of aspect any one of aspects 31-35, wherein the profiler or an emulator library includes a profiler library that provides an API for hooks or callbacks of performance statistics to the profiler.

Aspect 37. A non-transitory computer readable medium having computer-executable instructions stored thereon that, upon execution, cause one or more processors to perform operations for emulating a hardware accelerator comprising: running a guest system in a host system providing an emulation platform; providing a data processing command from the guest system; emulating a hardware accelerator with an accelerator emulator; receiving the data processing command to the hardware accelerator through a virtual device interface; controlling, with a controller component, an offloading hardware component of the hardware accelerator to emulate executing the data processing command by the hardware accelerator; and acquiring performance statistics from the guest system with a profiler.

Aspect 38. The non-transitory computer readable medium of aspect 37, further comprising: emulating a hardware accelerator in a Quick Emulator (QEMU) as a virtual device in communication with the guest system.

Aspect 39. The non-transitory computer readable medium of aspect 37 or 38, further comprising: storing data processed by the hardware accelerator emulated by the accelerator emulator in an emulated storage device.

Aspect 40. The non-transitory computer readable medium of any one of aspects 37-39, further comprising: implementing the hardware accelerator as a non-volatile memory express (NVMe) device, and providing a NVMe driver for controlling the NVMe device to execute the data processing command.

Aspect 41. The non-transitory computer readable medium of any one of aspects 37-40, further comprising running the profiler with a provided user application or an emulator library to collect the performance statistics.

Aspect 42. The non-transitory computer readable medium of any one of aspects 37-41, further comprising including a profiler library in the profiler or an emulator library that provides an API for hooks or callbacks of performance statistics to the profiler.

Aspect 43. The platform of any one of aspects 1-8, wherein the accelerator emulator is configured to emulate the hardware accelerator on a thread pool provided by one or more CPU cores.

Aspect 44. The platform of aspect 43, wherein the accelerator emulator is configured to emulate a plurality of hardware accelerators operated in parallel on the thread pool.

The terminology used in this specification is intended to describe particular embodiments and is not intended to be limiting. The terms “a,” “an,” and “the” include the plural forms as well, unless clearly indicated otherwise. The terms “comprises” and/or “comprising,” when used in this specification, specify the presence of the stated features, integers, steps, operations, elements, and/or components, but do not preclude the presence or addition of one or more other features, integers, steps, operations, elements, and/or components.

With regard to the preceding description, it is to be understood that changes may be made in detail, especially in matters of the construction materials employed and the shape, size, and arrangement of parts without departing from the scope of the present disclosure. This specification and the embodiments described are exemplary only, with the true scope and spirit of the disclosure being indicated by the claims that follow.

What is claimed is:

1. A platform for emulating hardware offloading, the platform, which when executed on a host system, comprises:
a guest system running on the host system, the guest system being configured to receive a data processing command;
a virtual device interface communicating between the guest system and an accelerator emulator; and
a hardware accelerator emulated by the accelerator emulator for executing the data processing command received through the virtual device interface, wherein the hardware accelerator including an offloading hardware component and a controller component.

2. The platform of claim 1, wherein
the controller component emulates parsing the data processing command from the guest system.

3. The platform of claim 1, wherein
the offloading hardware component emulates executing of the data processing command in the hardware accelerator.

4. The platform of claim 1, wherein
the hardware accelerator is emulated in a Quick Emulator (QEMU) as a virtual device in communication with the guest system.

5. The platform of claim 1, wherein
the host system includes an emulated storage device for emulating storing data processed by the hardware accelerator.

6. The platform of claim 1, wherein
the guest system further comprises an emulator library included in the guest system, the emulator library providing an application programming interface (API) to offload a data operation according to the data processing command to the hardware accelerator emulated by the accelerator emulator.

7. The platform of claim 1, wherein
the hardware accelerator is emulated by the accelerator emulator as a non-volatile memory express (NVMe) device, and
an emulator library includes a NVMe driver for controlling the NVMe device.

8. The platform of claim 1, further comprising a profiler acquiring performance statistics from the guest system.

9. The platform of claim 8, wherein the profiler runs with a provided user application or an emulator library to collect the performance statistics.

10. The platform of claim 8, wherein the profiler or an emulator library includes a profiler library that provides an API for hooks or callbacks of performance statistics to the profiler.

11. The platform of claim 8, wherein the accelerator emulator is configured to emulate the hardware accelerator on a thread pool provided by one or more CPU cores.

12. The platform of claim 11, wherein the accelerator emulator is configured to emulate a plurality of hardware accelerators operated in parallel on the thread pool.

13. A method for emulating a hardware accelerator, the method comprising:
a guest system running on a host system providing an emulation platform;
the guest system receiving a data processing command;
an accelerator emulator emulating the hardware accelerator;
the hardware accelerator receiving the data processing command through a virtual device interface; and
a controller component of the hardware accelerator controlling an offloading hardware component of the hardware accelerator to emulate executing the data processing command by the hardware accelerator.

14. The method of claim 13, wherein the accelerator emulator emulating a hardware accelerator in a Quick Emulator (QEMU) as a virtual device in communication with the guest system.

15. The method of claim 13, further comprising:
a profiler acquiring performance statistics from the guest system.

16. A non-transitory computer readable medium having computer-executable instructions stored thereon that, upon execution, cause one or more processors to perform operations for emulating a hardware accelerator comprising:
running a guest system in a host system providing an emulation platform;
receiving a data processing command from the guest system;
emulating a hardware accelerator using an accelerator emulator;
receiving into the hardware accelerator the data processing command through a virtual device interface; and
controlling an offloading hardware component of the hardware accelerator with a controller component of the hardware accelerator to emulate executing the data processing command by the hardware accelerator.

17. The non-transitory computer readable medium of claim 16, further comprising:
emulating with the accelerator emulator a hardware accelerator in a Quick Emulator (QEMU) as a virtual device in communication with the guest system.

18. The non-transitory computer readable medium of claim 16, further comprising:
storing data processed by the hardware accelerator in an emulated storage device emulated by the accelerator emulator.

19. The non-transitory computer readable medium of claim 16, further comprising:
implementing with the accelerator emulator the hardware accelerator as a non-volatile memory express (NVMe) device, and
providing a NVMe driver in an emulator library of the guest system for controlling the NVMe device to execute the data processing command.

20. The non-transitory computer readable medium of claim 16, further comprising:
acquiring performance statistics from the guest system with a profiler.
